(19) United States
(12) Patent Application Publication
(10) Pub. No.: US 2023/0107271 A1
(43) Pub. Date: Apr. 6, 2023

(54) MODELING BOUNDED RATIONALITY IN MULTI-AGENT SIMULATIONS USING RATIONALLY INATTENTIVE REINFORCEMENT LEARNING

(71) Applicant: salesforce.com, inc., San Francisco, CA (US)

(72) Inventors: Tong Mu, San Francisco, CA (US); Stephan Zheng, Redwood City, CA (US); Alexander Richard Trott, San Francisco, CA (US)

(21) Appl. No.: 17/554,379

(22) Filed: Dec. 17, 2021

Related U.S. Application Data
(60) Provisional application No. 63/252,546, filed on Oct. 5, 2021.

(51) Int. Cl. G06N 3/08; G06N 3/04

(52) U.S. Cl. CPC G06N 3/08; G06N 3/0472; G06N 3/0445; G06N 3/0454

(57) ABSTRACT

A rational inattention reinforcement learning (RIRL) framework determines actions of actors based on observations while modeling human irrationality or rational inattention. The RIRL framework decomposes observations into a set of observations, and passes the set through multiple information channels modeled as encoders having different information costs. Discriminators of the encoders measure a cost of mutual information (MI) associated with the observations. A stochastic action module of the RIRL framework receives encodings of the encoders and a history of encoded information from a previous iteration, and generates a distribution of actions. The stochastic action module includes a discriminator for measuring a cost of MI associated with the stochastic action module. The RIRL framework computes a reward based on the cost of MI of stochastic encoders, the cost of MI of the stochastic action module, and the distribution of actions. From the reward, the actions of the actors are determined.

### CROSS-REFERENCE TO RELATED APPLICATIONS

This application is a nonprovisional of and claims priority under 35 U.S.C. 119 to U.S. Provisional Application No. 63/252,546, filed Oct. 5, 2021, which is hereby expressly incorporated by reference herein in its entirety.

### TECHNICAL FIELD

The embodiments are directed to reinforcement learning frameworks, and more specifically to a rational inattention reinforcement learning framework.

### BACKGROUND

Multi-agent reinforcement learning (MARL) has shown great utility in complex agent-based simulations in economics, games, and other fields. In such simulations, the behavioral rules of agents may be too difficult for designers to specify. Instead, when using MARL, designers specify objective functions for the agents and use reinforcement learning (RL) to learn agent behaviors that optimize the specified objectives. This approach may be problematic when simulating systems of human agents. This is because agents behave rationally and execute the objective-maximizing behavior, in contrast to established models of human decision-making. For instance, behavioral economics has found that humans are often irrational due to various cognitive biases and limitations. Additionally, the models of irrationality yield results and implications that are significantly different from the results obtained using rationality assumptions. Therefore, human irrationality should be accounted for when simulating systems involving human(-like) agents.

### BRIEF DESCRIPTION OF THE DRAWINGS

FIG. 1 is a simplified diagram of a computing device for implementing a rational inattention reinforcement learning (RIRL) framework, according to some embodiments.

FIG. 2 is a simplified diagram of a rational inattention reinforcement learning (RIRL) framework, according to some embodiments.

FIG. 3 is a flowchart of a method for modeling bounded rationality using the RIRL framework, according to some embodiments.

FIG. 4 is a diagram illustrating an RIRL framework modeling a principal-agent problem, according to some embodiments.

FIGS. 5A-5D are diagrams illustrating results of an RIRL framework analyzing a principal-agent problem, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The embodiments are directed to a rational inattention reinforcement learning (RIRL) framework. The RIRL framework may be a MARL framework with agents that may be rationally inattentive. Rational inattention (RI) model is a model of bounded rationality. The RI model attributes human irrationality to the costliness of mental effort (e.g. attention) required to identify the optimal action. Mathematically, the RI model measures these costs as the mutual information (MI) between the variables considered by the decision process and the decisions ultimately made. This captures the intuition that a policy has a higher cognitive cost if its execution requires more information about the state of the world and thus more attention. When used to model sub-optimal behavior, the RIRL framework may rationalize seemingly sub-optimal behavior by including the cognitive cost in the reward function, i.e., by adding the MI cost(s). In this way, the “rational” behaviors of the RIRL-agent may mimic human-like bounded rationality.

The RIRL framework is a tool for modeling boundedly rational (sub-optimal) behavior and its emergent consequences in multi-agent systems. In some embodiments, the RIRL framework may model classical economic settings intractable under the conventional frameworks.

The RIRL framework extends the single-timestep framework which decomposes decision-making into two steps: stochastic perception followed by stochastic action. The stochastic perception and the stochastic action are each subjected to their own MI cost. The RIRL framework generalizes the stochastic perception to multiple information channels with heterogeneous costs, hidden-state policy models, and sequential environments. The RIRL framework also provides a general-purpose technique to compute MI-based rewards and a novel boundedly-rational policy class. This allows the RIRL framework to model settings with rich cognitive cost structures, e.g., when information about some state variables may be more difficult to observe than others. For example, when applying for a job, a job candidate's past job performance may be more relevant than her overall employment history but also harder to evaluate by a hiring manager.

The RIRL framework may analyze complex scenarios that conventional frameworks may not. For instance, the RIRL framework may study a principal-agent (PA) problem, where a principal and agent are computing entities that simulate human behavior and where a principal is boundedly rational. In the PA problem, a principal employs one or more agents, but both parties have misaligned incentives and/or asymmetric information. For example, a profit-maximizing employer (e.g. the principal) must consider the best compensation scheme for motivating a (team of) employee(s) (e.g. agents) to work. However, it is difficult for the employer to determine how much and what work the employee(s) actually do(es).

A real-world PA experiments have shown that bounded rationality is key to explaining marked deviations between equilibria reached by human participants and theoretical predictions reached by the computer simulations under rational assumptions. This is partially because theoretical analyses of PA problems often rely on stylized modeling assumptions, e.g., rationality or linearity, to be tractable. Additionally, the RIRL framework enables more flexible and natural models of information asymmetry. Rather than assuming certain information is not available, the principal is allowed to (implicitly) choose how much information to observe and pay a cost to do so.

The RIRL framework may analyze generalized PA problems that are analytically intractable, such as a sequential PA problem with multiple computing agents, using heterogeneous information channels. Across all settings, the equilibrium behavior depends strongly on the cost of attention and differs from the behavior under rational assumptions. Depending on the channel, increasing principal's inattention may either increase the agent's welfare dur to increased compensation or decrease agent's welfare dur to encouraging additional work. Further, the RIRL framework indicates agents implementing different strategies, which may be referred to as signaling. These strategies may include agents learning to misrepresent their ability. The RIRL framework may be a bounded tool to model bounded rational (sub-optimal) behavior and analyze emergent consequences in multi-agent systems.

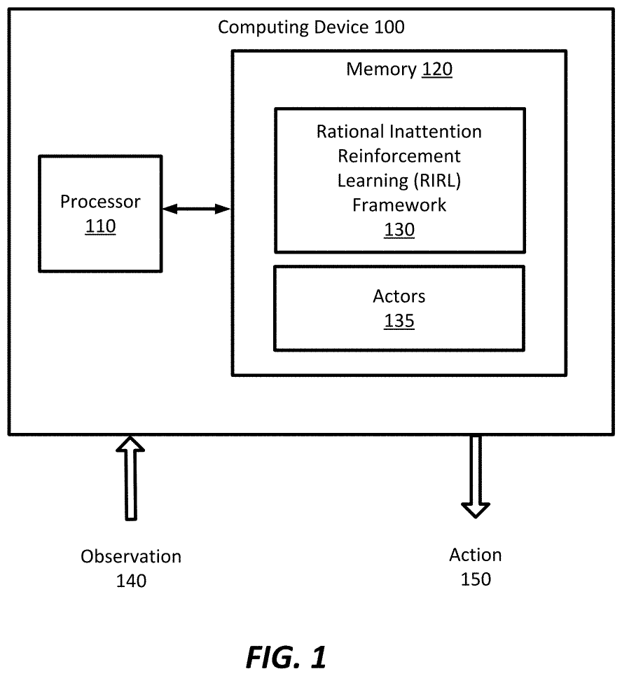

FIG. 1 is a simplified diagram of a computing device 100 with a rational inattention reinforcement learning, according to some embodiments. As shown in FIG. 1, computing device 100 includes a processor 110 coupled to memory 120. Operation of computing device 100 is controlled by processor 110. And although computing device 100 is shown with only one processor 110, it is understood that processor 110 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 100. Computing device 100 may be implemented as a stand-alone subsystem, as a board added to a computing device, and/or as a virtual machine.

Memory 120 may be used to store software executed by computing device 100 and/or one or more data structures used during operation of computing device 100. Memory 120 may include one or more types of machine readable media. Some common forms of machine readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 110 and/or memory 120 may be arranged in any suitable physical arrangement. In some embodiments, processor 110 and/or memory 120 may be implemented on a same board, in a same package (e.g., system-in-package), on a same chip (e.g., system-on-chip), and/or the like. In some embodiments, processor 110 and/or memory 120 may include distributed, virtualized, and/or containerized computing resources. Consistent with such embodiments, processor 110 and/or memory 120 may be located in one or more data centers and/or cloud computing facilities.

In some examples, memory 120 may include a non-transitory, tangible, machine readable media that includes executable code that when run by one or more processors (e.g., processor 110) may cause the one or more processors to perform the methods described in further detail herein. In some embodiments, Memory 120 stores a rational inattention reinforcement learning (RIRL) framework 130 discussed above. The RIRL framework 130 may be a neural network or a combination of neural networks trained to simulate emerging behavior of computing actors 135 in computing simulations. The computing actors 135 are actors that emulate human behavior, such as a principal and agent(s) in the principal-agent problem. The computing simulations may be simulations associated with a simulated real-world, economic behavior, or gaming environment. Unlike conventional frameworks, the RIRL framework 130 is trained to incorporate a human irrationality component, also referred to as rational inattention (RI), into the actor's behavior. In other words, the RIRL framework 130 simulates the actors 135 thinking irrationally to account for irrationality component of the human behavior. The RIRL framework 130 models human irrationality as the cost of cognitive information processing using mutual information of other actors' in the environment.

In some embodiments, the RIRL framework 130 receives observations 140 as input. The observations 140 may be observations associated with a particular environment and may be made by actors 135. Observations 140 may be observed by one, all, or a subset of actors 135, and RIRL framework 130 may be trained to determine actions from observations of different actors. Based on observations 140, the RIRL framework 130 may generate actions 150 that may be taken by actors 135. The RIRL framework 130 may also determine rewards for taking the actions 150.

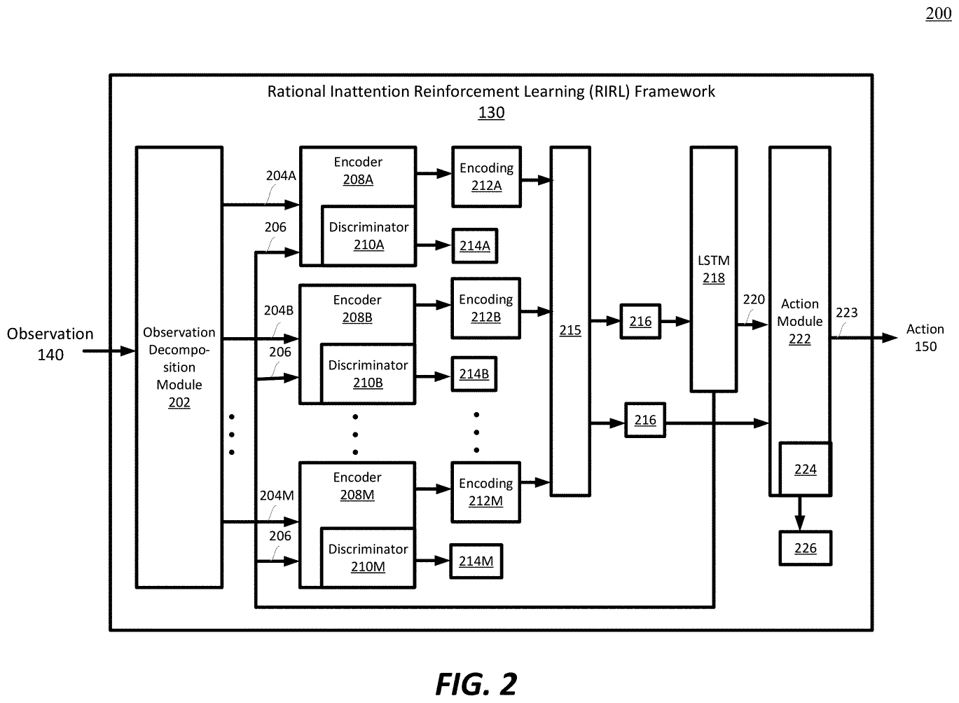

FIG. 2 is a block diagram 200 of an RIRL framework, according to some embodiments. The RIRL framework 130 may simulate behavior of multiple actors, in various simulated environments, including in partially-observable Markov Games. A Markov Game may be defined by (S, A, r, [symbol] , γ, O, I), where S is the state space of the game, A is the combined action spaces of the actors, and I are actor indices. The portion of the game state s that actor i (one of actors 135 in FIG. 1) can observe may be denoted as Oᵢ=O(s, i). In addition, Oᵢ may include a (possibly learnable) encoding of the observation history. Each game episode has a horizon of T≥1 timestep(s). At each timestep t, actor i selects action a_{i,t} according to a stochastic policy πᵢ (a_{i,t}|o_{i,t}). The transition function T determines how the game state evolves based on actions taken. Each actor's objective is encoded in its reward function rᵢ(s, a), where boldface denotes concatenation across actors. When modeling economic behavior, reward is taken to be the (marginal) utility Uᵢ(sₜ, aₜ) actor i earns in state sₜ given the joint actions aₜ. Each actor optimizes its policy to maximize its (discounted) sum of future rewards, with discount factor γ.

While conventional reinforcement learning frameworks may be used to discover approximate utility-maximizing policies, simulations built from such “rational” behavior fail to account for the characteristic irrational behavior of human decision makers. Behavioral economic models may account for such patterns as consequences of inattention. The RIRL framework 130 uses rational inattention to formalize this intuition using a modified objective. The modified objective includes a cost to the mutual information Ĩ(aᵢ; oᵢ) between the (observable) state of the world oᵢ and the actions aᵢ˜πᵢ(⋅|oᵢ). This definition captures the intuition that if the agent puts in more effort to pay attention to observation oᵢ, its action aᵢ likely becomes more correlated with the observation oᵢ, and thus resulting in a high mutual information (MI).

In the one-step setting, the optimal rationally inattentive policy πᵢ^{†} may be given by:

$${π}_{i}^{†} = \frac{arg max}{{π}_{i}} ( {𝔼}_{π} [ {U}_{i} ( s , a ) ] - λ I ( {a}_{i} ; {o}_{i} ) ) \qquad ( 1 )$$

Note that this is equivalent to learning the optimal policy for adjusted reward function rᵢ^{†}, where reward may be as follows:

rᵢ^{†}(sₜ,aₜ)=Uᵢ(sₜ,aₜ)−λĨ(a_{i,t};o_{i,t}), (2)

The mutual information Ĩ(a_{i,t}; o_{i,t})=log p(a_{i,t}; o_{i,t})−log p (a_{i,t})p(o_{i,t}) is a Monte Carlo (MC) estimate of I(aᵢ; oᵢ) and λ is the utility cost per bit of information. The terms p(aᵢ, oᵢ),p(aᵢ) and p(oᵢ) are the joint and marginal distributions over aₜ and oᵢ (i.e. the observations and associated actions for actor i) induced by the environment and the set of actors' policies π.

The RIRL framework 130 may estimate the mutual information. To estimate the mutual information, the RIRL framework 130 may utilize a general-purpose module for estimating Ĩ_{π}_{ᵢ}(aᵢ; oᵢ), i.e., the single sample MC estimate of mutual information between oᵢ and aᵢ˜πᵢ (aᵢ; oᵢ), where πᵢ is the policy network. Given the pair (aᵢ; oᵢ), RIRL framework 130 may estimate Ĩ_{π}_{ᵢ}(aᵢ; oᵢ) from the ratio between log p(aᵢ; oᵢ) (the log-odds under the joint distribution) and log p(aᵢ)p(oᵢ) (the log-odds under the factorized distribution). This ratio can be estimated using discriminator d_{π}_{ᵢ}(aᵢ, oᵢ) that learns to classify whether the sample (aᵢ, oᵢ) came from the joint or factorized distribution. Samples from p(aᵢ, oᵢ) are generated naturally during on-policy rollouts, and samples from p(aᵢ) p(oᵢ) may be generated by shuffling a batch of samples from the joint distribution. As such, on-policy rollout data can be used to optimize π and to train discriminator d_{π}_{ᵢ}, and compute the RI reward r_{i,t}^{†} by subtracting λĨ_{π}_{ᵢ}(a_{i,t}; o_{i,t}) from the default (utility-based) reward r_{i,t} shown as r_{i,t}^{†}=r_{i,t}−λĨ_{π}_{ᵢ}(a_{i,t}; o_{i,t}). Notably, other techniques for measuring mutual information may also be used.

As discussed above, the RIRL framework 130 may decouple an action from a perception using multiple information channels. The RIRL framework 130 penalizing the I(aᵢ; oᵢ), models the intuition that information about the e.g. observable state of the world is costly to obtain or use. To support richer modeling, the RIRL framework 130 may comprise multiple channels of information with heterogeneous cognitive costs. For example, when purchasing a used car, information about the prices of available cars is much easier to come by than information about their conditions. The RIRL framework 130 may model the prices of available cars and their conditions as separate information channels associated with different cognitive costs.

To that end, the RIRL framework 130 extends the action-perception decoupling strategy, which models a policy π(a|s) using a stochastic perception module q(y|s) followed by an action module p(a|y), jointly trained to optimize an RI-style reward r(s, a)=λ_{q}I_{q}(y; s)−λₚIₚ(a; y). The RIRL framework 130 may have a policy class that can flexibly model scenarios where different information channels (i.e. partitions of o) have different processing costs λ^{m}. The RIRL framework 130 may also use recurrent policies which may allocated processing costs strategically over time.

In some embodiments, RIRL framework 130 may decompose a given actor observation oₜ state into a set of M≥1 observations oₜ={oₜ¹, . . . , oₜ^{M}}, with oₜ^{m} being an observation from information channel m. As illustrated in FIG. 2, RIRL framework 130 includes an observation decomposition module 202. Once RIRL framework 130 receives observation 140, the observation decomposition module 202 may decompose observation 140 into multiple observations, such as observations oₜ={oₜ¹, . . . , oₜ^{M}} (shown as observations 204A-M in FIG. 2).

The RIRL framework 130 may include encoders 208, such as encoders 208A-M. There may be a configurable number of encoders 802A-M. The RIRL framework 130 assumes that each channel has an associated information cost, given as Δ={λ¹, . . . , λ^{m}} for encoders 208. Each information channel may be one of encoders 208A-M. Encoders 208A-M may be stochastic encoders. For each channel, the RIRL framework 130 is trained on a separate encoder ƒ^{m}(yₜ^{m}|oₜ^{m}, ψₜ) (encoders 208A-M), which receives oₜ^{m} and recurrent state ψₜ (shown as 206) of a long-short term memory (LSTM) 218 (discussed below) as inputs and outputs encodings 212A-M. Encoding 212A-M may be parameters, such as means and standard deviations of a stochastic encoding yₜ^{m}. The encoders ƒ^{m} are illustrated in FIG. 2 as encoders 208A-208M, with encoder 208A being associated with the first channel, encoder 208B being associated with a second channel, etc. In some embodiments, encoders 208A-M are stochastic encoders. Each encoder ƒ^{m} may be implemented as a residual-style encoder, with samples given by:

μₜ^{m},σₜ^{m}=ƒ^{m}(oₜ^{m},ψₜ) (3)

yₜ^{m}=oₜ^{m}+μₜ^{m}+σₜ^{m}·ϵₜ^{m} (4)

where ϵₜ^{m} is a random sample from a spherical Gaussian with dimensionality equal to that of y^{m} and o^{m}.

In some embodiments, encoders ƒ^{m} (encoders 208A-M) may include discriminators 210A-M. For example, encoder 208A may include discriminator 210A, encoder 208B may include discriminator 210B, etc. During the training phase, for each one of encoders ƒ^{m} (208A-M), a corresponding discriminator d_{ƒm}(yₜ^{m}, [oₜ^{m}, ψₜ]) (shown as discriminators 210A-210M) is trained to estimate mutual information Ĩ_{ƒm}(yₜ^{m}; [oₜ^{m}, ψₜ]) (shown as 214A-214M). The estimated Ĩ_{ƒm}(yₜ^{m}; [oₜ^{m}, ψₜ]) is the cost of the mutual information associated with encoders 208A-M.

In some embodiments, encodings 212A-M may be concatenated using a concatenation module 215 into a full encoding 216. Encoding 216 may be represented as encoding yₜ=[yₜ¹, . . . , yₜ^{M}] of oₜ observations concatenated across all M encoder samples (encodings 212A-M) generated by encoders 208A-M.

LSTM 218 may receive the full encodings 216 and update the internal state ψₜ of the LSTM 218 with full encodings 216. In other words, LSTM 218 may maintain a history of encoded information: ψₜ₊₁=LSTM(yₜ, ψₜ) (shown as 220). The previous or non-updated state ψₜ (shown as 206) of LSTM 218 may be propagated as input to encoders 208A-M as discussed above.

The observation decomposition module 202, encoders 802A-M, concatenation module 215 and LSTM 218 may be components of the stochastic perception module, discussed above.

Full encodings yₜ (216) and updated LSTM state ψₜ₊₁ (220) are inputs to a stochastic action module ω(aₜ|tₜ₊₁) (shown as an action module 222). Action module 222 may output a probability distribution over actions 223, from which actions 150 may be selected. In some embodiments, action module 222 may be a neural network, such as a multi-layer perceptron network. Action module 222 may also include a discriminator 224 that generates an estimate Ĩ_{ƒm}(aₜ; [oₜ^{m}, ψₜ]). The estimated Ĩ_{ƒm}(aₜ; [oₜ^{m}, ψₜ]) is a cost of mutual information 226 of the action module 222.

During the training phase, the RIRL framework 130 may be trained with policy gradients, as shown below:

Δπ∝ [symbol] (∇ log π(yₜ¹, . . . ,yₜ^{M},aₜ|sₜ,ψₜ,ψₜ₊₁)rₜ^{†}), (5)

log π(yₜ¹, . . . ,tₜ^{M},aₜ|sₜ,ψₜ,ψ_{t+′})=log ω(aₜ|yₜ,ψ′ₜ₊₁)+Σₘ₌₁^{M} log ƒₘ(yₜ^{m}|oₜ^{m},ψₜ), (6)

rₜ^{†}=U(sₜ,aₜ)−λ_{w}Ĩ_{w}(aₜ|yₜ,ψₜ₊₁)−Σₘ₋₁^{M}λ^{m}Ĩ_{ƒ}_{^{m}}(yₜ^{m};[oₜ^{m},ψₜ]) (7)

Notably, the reward rₜ^{†} generated by the RIRL framework 130 takes into account the cost of information Ĩ_{ƒ}_{^{m}}(yₜ^{m}; [oₜ^{m}, ψₜ]) of the stochastic perception module which is shown as 214A-M and the cost of information of information Ĩ_{w}(aₜ|yₜ, ψₜ₊₁) the action module 222, shown as 226 in FIG. 2. Once trained, RIRL framework 130 generates a probability of actions from which action 150 for actors or agents are generated based on observations 140.

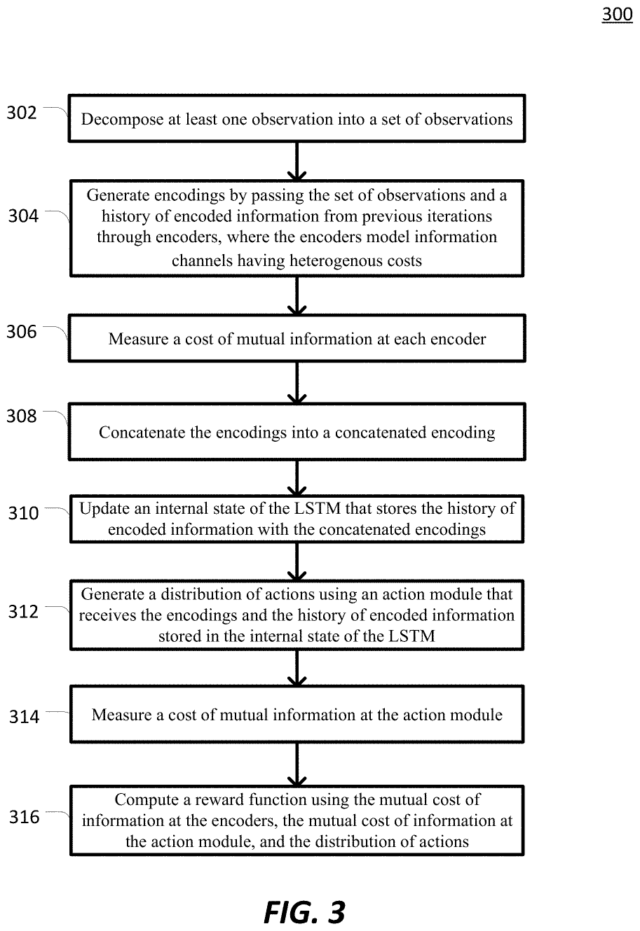

FIG. 3 is a simplified diagram of a method 300 for modeling bounded rationality using an RIRL framework, according to some embodiments. One or more of the processes 302-316 of method 300 may be implemented, at least in part, in the form of executable code stored on non-transitory, tangible, machine-readable media that when run by one or more processors may cause the one or more processors to perform one or more of the processes 302-316. Processes 302-316 may repeat multiple times.

At process 302, at least one observation is decomposed into a set of observations. For example, RIRL framework 130 may receive and decompose observation 140 into a set of observations 204A-M.

At process 304, the set of observations are passed through multiple information channels. As discussed above, the RIRL framework 130 includes a stochastic perception module with multiple information channels having heterogenous costs. The information channels may be modeled as encoders 208A-M. The set of observations 204A-M along with recurrent state 206 of LSTM 218 are passed through corresponding encoders 208A-M to generate encodings 212A-M.

At process 306, a cost of mutual information (MI) at encoders of a stochastic perception module is measured. As discussed above, encoders 208A-M include corresponding discriminators 210A-M. As the set of observations 204A-M are passed through encoders 208A-M that are the multiple information channels having heterogenous costs, discriminators 210A-M estimate the cost of MI 214A-M. In some embodiments, process 304 may be performed in parallel with process 304.

At process 308, encodings 212A-M are concatenated. For example, RIRL framework 130 may concatenate encodings 212A-M into concatenated encodings 216. Concatenated encodings 216 may be in a form of a vector.

At process 310, a concatenated encoding is stored in an LSTM. For example, RIRL framework 130 may store the concatenated encodings 216 in the internal state ψₜ (206) in the LSTM 218. LSTM 218 may maintain history of encoded information. That is, LSTM 218 may include an internal state ψₜ (206) that is updated with concatenated encodings 216. The updated internal state of the LSTM is internal state ψₜ₊₁ (220).

At process 312, a distribution of actions are generated. Action module 222 of the RIRL framework 130 may receive the concatenated encodings 216 and a history of encoded information as internal LSTM state ψₜ₊₁ (220), and generate a distribution of actions from which actions 150 are selected.

At process 314, a cost of MI of an action module is measured. For example, action module 222 may include discriminator 224 that measures the cost of mutual information 226.

At process 316 a reward function is computed. The RIRL framework 130 computes a reward function using the cost of mutual information 214A-M, the cost of mutual information 226, and actions 150.

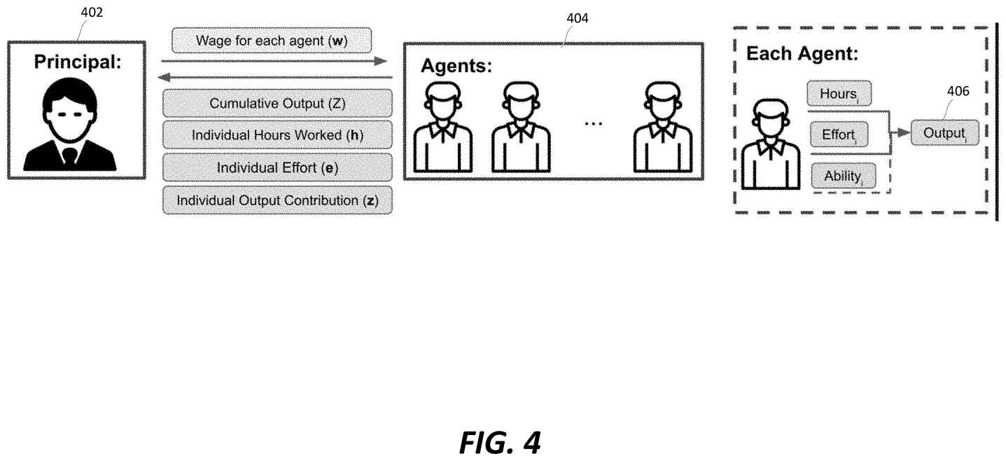

Going back to FIG. 1, in some embodiments, the RIRL framework 130 may be used to model sequential principal-agent problems. FIG. 4 illustrates an RIRL framework modeling a principal-agent problem at time t, according to some embodiments. As illustrated in FIG. 4, the principal agent problem may have multiple actors that include a principal 402 and multiple agents 404. The principal-agent problem may have a sequence that has T>1 timesteps in each episode and nₐ=4 agents 404 that have K=5 possible agent abilities k. The principal 402 cannot see the agents' 404 abilities. Each agent's 404 ability may be sampled randomly at the start of each episode. At each timestep t, an output 406 of agent 404 (shown as agent i) may be determined as:

z_{i,t}=h_{i,t}(vᵢ^{k}+e_{i,t}), (8)

where agent i works h_{i,t} hours and exerts effort e_{i,t}. The principal 402 may move first and set a wage ω_{i,t}. Each agent i may move second. Agent i may know wage ω_{i,t} before choosing work hours h_{i,t} and e_{i,t}, and in return earning income ω_{i,t}×h_{i,t}. The utility Uₚ of principal 402 measures profit. The utility Uₐ may be defined using standard utility functions, where the optimal hours h increases with the wage ω. As a consequence of this configuration, the profit-maximizing wage ωᵢ for agent i increases with its ability vᵢ^{k}. The agent's utility may be determined as follows:

$${U}_{a} ( ω , h , e ) = \underbrace{CRRA ( ω \cdot h ; ρ )}_{Income Utility} - \underbrace{{c}_{i} {h}^{α} ( 1 + e )}_{Work Disutility} , \underbrace{{U}_{p} ( ω , h , z )}_{Profit} = \underbrace{{\sum }_{i ∈ [ {n}_{a} ]}}_{Revenue} {z}_{i} - \underbrace{{\sum {ω}_{i} {h}_{i}}_{i ∈ [ {n}_{a} ]}}_{Wages Paid} , \qquad ( 9 )$$

where ρ, cᵢ and α are constants governing the shape of Uₐ.

In some embodiments, a strategic principal 402 may infer private features of agent 404. Example features may be the agent's ability. Further, the agent's equilibrium behavior may depend on any inference costs the agent experiences, e.g., attention costs. In some embodiments, to isolate and explore the effects of distinct principal attention costs, attention costs are not imposed on the agents 404. In this case, the agents' reward is the agents' utility r_{i,t}=Uₐ(ψ_{i,t}, h_{i,t}, e_{i,t}).

For principal 402, RIRL framework 130 may be trained with three information channels (M=3). The first channel may have an “easy” and low-cost to observe agents 404, and the second and third channels may have a “hard” and high-cost. The low-cost channel oₚ^{ƒ} may include information that may be freely available (λ^{ƒ}=0). This information may be the time t, the hours agents 404 worked h (e.g. timesheets may be available which makes hours hᵢ agent i worked easy to determine), and the total output, Z=Σ_{i∈[n}_{ₐ}_{]} zᵢ (principal 402 may see the final result). The high-cost may be to see individual contributions. For example, a high-cost channel oₚ^{e} may determine the cost of efforts e, and a high-cost channel oₚ^{z} may determine the outputs z. This model may represent principal 402 who may spend time and attention to observe individual agents 404 to reduce uncertainty about their true ability, e.g., their working styles and productivity. By modeling the attention cost of output and effort separately, RIRL framework 130 may identify the effects and interactions of unequal observation costs. The principal's reward may be defined as:

$${r}_{p , t}^{†} = {U}_{p} ( {ω}_{t} , {h}_{t} , {z}_{t} ) - \underbrace{{λ}^{z} \tilde{I} ( {y}_{t}^{z} ; {z}_{t} )}_{Individual Output and} - \underbrace{{λ}^{e} \tilde{I} ( {y}_{t}^{e} ; {e}_{t} )}_{Effort Perception Cost} \qquad ( 10 )$$

As such, the bounded rationality of principal 402 may be modeled through the cost to get information about effort and individual outputs of agents 404. The RIRL framework 130 for principal-actor architecture may also use attention costs Ĩ(yₜ^{θ}; oₜ^{ƒ}) and Ĩ(ωₜ; yₜ), which are omitted for purposes of simplicity.

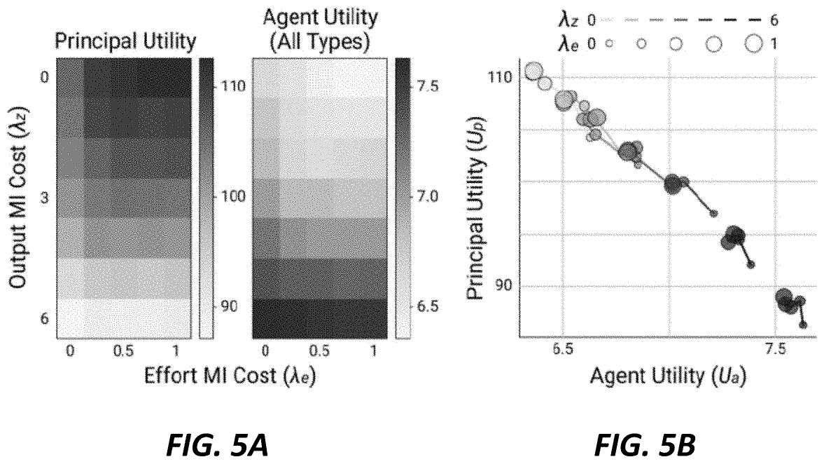

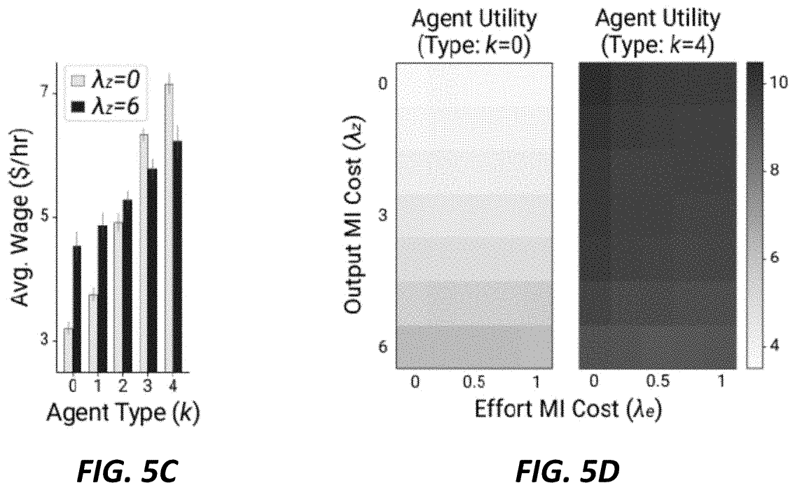

The results of the RIRL framework 130 analyzing the principal-agent problem are shown in FIGS. 5A-5D, according to some embodiments. FIGS. 5A and 5B illustrate that at equilibrium, the principal and agent utilities are negatively correlated. This is illustrated by comparing across varying levels of (λ^{z} and λₑ), where the “rational” model has λ^{z}=λ^{e}=0. This indicates that the principal's bounded rationality has opposing implications for the principal 402 and agents 404. As illustrated in FIG. 5A, the agents' average utility increases and the principal's utility decreases when the principal's attention cost for individual outputs λ^{z} increases. Conversely, agent utility decreases with increasing principal attention cost on effort λ^{e}.

This is because the principal 402 has a different optimal wage for each ability v^{k} as shown in FIG. 5C. When the principal 402 is fully rational it can use output and effort to accurately infer ability. Further, increasing attention costs (e.g. cost of output λ^{z}) leads the principal 402 to set wages in a manner that is less profitable but also less attentionally demanding. At the resulting equilibria, the principal 402 has more uncertainty over each agent's type and adopts a “better safe than sorry approach” and increases the average wage to ensure output. In sum, the same force that creates a lower-utility equilibrium for the principal 402 has higher average utility for the agents 404.

Further, higher λ^{z} increases the cost of distinguishing between the individual outputs of each agent i. Consequentially, while the agent i's utility increases with λ^{z}, the agent utility does not increase for all agent types. Specifically, the utility of the (highest) lowest-ability agent's increases. Hence, the principal's uncertainty over individual outputs decreases the wage (and utility) differences between agents of different ability as illustrated in FIGS. 5C and 5D. This observation is particularly relevant when considering welfare based not only on the average agent utility but on the distribution of utility across agent types, e.g. the equality of utility.

Some examples of computing devices, such as computing device 100 may include non-transitory, tangible, machine readable media that include executable code that when run by one or more processors (e.g., processor 110) may cause the one or more processors to perform the processes of method 300. Some common forms of machine readable media that may include the processes of method 300 are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A method, comprising:
decomposing, using a rational inattention reinforcement learning (RIRL) framework implemented as a neural network, at least one observation into a set of observations;
passing the set of observations through stochastic encoders of the RIRL framework to generate encodings, wherein the stochastic encoders model multiple information channels, one observation in the set of observations associated with one information channel in the multiple information channels;
measuring, using discriminators of the stochastic encoders, a cost of mutual information (MI) associated with the set of observations;
receiving, at a stochastic action module of the RIRL framework, the encodings and a history of encoded information, and generating a distribution of actions;
measuring, using a discriminator of the stochastic action module, a cost of MI associated with the stochastic action module; and
computing a reward using the cost of MI associated with the stochastic encoders, the cost of MI associated with the stochastic action module, and the distribution of actions.

2. The method of claim 1, wherein a stochastic encoder of the stochastic encoders is associated with an information cost that is different from information costs associated with other encoders in the stochastic encoders.

3. The method of claim 1, further comprising:
determining, using a discriminator of a stochastic encoder, a cost of mutual information associated with an observation from the set of observations passed through the stochastic encoder; and
determining, using other discriminators of other encoders in the stochastic encoders, costs of mutual information, wherein the cost of mutual information determined by the discriminator is different from the costs of mutual information determined by the other discriminators.

4. The method of claim 1, further comprising:
passing through the stochastic encoders a history of encoded information from a previous iteration together with the set of observations.

5. The method of claim 4, further comprising:
storing, in a long-short term memory (LSTM), the history of encoded information from the previous iteration as an internal state of the LSTM.

6. The method of claim 1, further comprising:
concatenating the encodings from the stochastic encoders into concatenated encodings; and
updating an internal state of an LSTM storing a history of encoded information from a previous iteration with the concatenated encodings, wherein subsequent to the updating the internal state of the LSTM stores the history of encoded information.

7. The method of claim 6, wherein the stochastic action module receives the concatenated encodings.

8. A system, comprising:
a memory storing a rational inattention reinforcement learning (RIRL) framework; and
a processor coupled to the memory that causes the RIRL framework to:
decompose at least one observation into a set of observations;
pass the set of observations through stochastic encoders to generate encodings, wherein the stochastic encoders model multiple information channels, one observation in the set of observations for one information channel in the multiple information channels;
measure, using discriminators of the stochastic encoders, a cost of mutual information (MI) associated with the set of observations;
receive, at a stochastic action module implemented as a neural network, the stochastic encodings and a history of encoded information, and generate a distribution of actions;
measure, using a discriminator of the stochastic action module, a cost of MI associated with the stochastic action module; and
compute a reward using the cost of MI associated with the stochastic encoders, the cost of MI associated with the stochastic action module, and the distribution of actions.

9. The system of claim 8, wherein a stochastic encoder of the stochastic encoders is associated with an information cost that is different from information costs associated with other encoders in the stochastic encoders.

10. The system of claim 8, wherein a discriminator of a stochastic encoder determines a cost of mutual information associated with an observation passed through the stochastic encoder that is different from costs of mutual information of discriminators associated with other encoders in the stochastic encoders.

11. The system of claim 8, wherein the processor is further configured to:
pass through the stochastic encoders a history of encoded information from a previous iteration together with the set of observations.

12. The system of claim 11, wherein the processor is further configured to:
store the history of encoded information from the previous iteration in an internal state in a long-short term memory (LSTM).

13. The system of claim 8, wherein the processor is further configured to:
concatenate the encodings from the stochastic encoders into concatenated encodings;
update an internal state of an LSTM storing a history of encoded information from a previous iteration with the concatenated encodings, wherein subsequent to the update the internal state of the LSTM stores the history of encoded information; and
pass the concatenated encodings through the stochastic action module.

14. The system of claim 8, wherein the processor is further configured to:
determine an action for a computing actor based on the reward.

15. A non-transitory computer-readable medium having instructions stored thereon, that when executed by a processor cause the processor to perform operations, the operations comprising:
decomposing, using a rational inattention reinforcement learning (RIRL) framework implemented as a neural network, at least one observation into a set of observations;
passing the set of observations through stochastic encoders of the RIRL framework to generate encodings, wherein the stochastic encoders are multiple information channels, one observation in the set of observations associated with one information channel in the multiple information channels;
measuring, using discriminators of the stochastic encoders, a cost of mutual information (MI) associated with the set of observations;
receiving, at a stochastic action module of the RIRL framework, the encodings and a history of encoded information, and generating a distribution of actions;
measuring, using a discriminator of the stochastic action module, a cost of MI associated with the stochastic action module; and
computing a reward using the cost of MI associated with the stochastic encoders, the cost of MI associated with the stochastic action module, and the distribution of actions.

16. The computer-readable medium of claim 15, wherein a stochastic encoder of the stochastic encoders is associated with an information cost that is different from information costs associated with other encoders in the stochastic encoders.

17. The computer-readable medium of claim 15, further comprising:
determining, using a discriminator of a stochastic encoder, a cost of mutual information associated with an observation passed through the stochastic encoder; and
determining, using other discriminators of other encoders in the stochastic encoders, costs of mutual information, wherein the cost of mutual information determined by the discriminator is different from the costs of mutual information determined using the other discriminators.

18. The computer-readable medium of claim 15, further comprising:
passing, through the stochastic encoders, a history of encoded information from a previous iteration together with the set of observations.

19. The computer-readable medium of claim 18, further comprising:
storing, in a long-short term memory (LSTM), the history of encoded information from the previous iteration as an internal state of the LSTM.

20. The computer-readable medium of claim 15, further comprising:
concatenating the encodings from the stochastic encoders into concatenated encodings; and
updating an internal state of an LSTM storing a history of encoded information from a previous iteration with the concatenated encodings, wherein subsequent to the updating the internal state of the LSTM stores the history of encoded information.
